(19) United States
(12) Patent Application Publication
(10) Pub. No.: US 2010/0161210 A1
(43) Pub. Date: Jun. 24, 2010

(54) Method of Determining a Rendezvous and Related Personal Navigation Device

(76) Inventor: Andrew Watkins, Auckland (NZ)

Correspondence Address: NORTH AMERICA INTELLECTUAL PROPERTY CORPORATION, P.O. BOX 506, MERRIFIELD, VA, 22116, US

(21) Appl. No.: 12/343,509

(22) Filed: Dec. 24, 2008

(51) Int. Cl. G01C 21/36

(52) U.S. Cl. 701/201

(57) ABSTRACT

To aid users of personal navigation devices in determining a rendezvous between the personal navigation devices, a first location corresponding to a first personal navigation device is received, and a second location corresponding to a second personal navigation device is received. The rendezvous is determined based on the first location and the second location, and then sent to the first personal navigation device and the second personal navigation device. The first personal navigation device determines a first route from the first location to the rendezvous, and the second personal navigation device determines a second route from the second location to the rendezvous.

### BACKGROUND OF THE INVENTION

1. Field of the Invention

The present invention relates to personal navigation devices, and more particularly, to a method of determining a rendezvous location for at least two personal navigation devices.

2. Description of the Prior Art

A number of navigation methods have been employed over the centuries by sailors desiring to go from one place to another without getting lost on the way or passing through dangerous waters. Whereas in the past, navigation was typically of interest to navigators on marine vessels, as more advanced navigation systems are developed, drivers, hikers, and tourists are rapidly adopting Global Navigation Satellite System (GNSS) personal navigation devices (PNDs) as aids in their travels.

One key to navigation is positioning, or the art of knowing precisely where one is at any given moment. In the past, positioning was accomplished through use of a sextant, which measures angular positions of celestial bodies relative to the horizon. Today, positioning can be accomplished with fair accuracy by GNSS receivers. Currently, only the NAVSTAR Global Positioning System (GPS) developed by the United States Department of Defense offers comprehensive positioning satellite coverage around the globe, though other systems should become operational by the year 2010.

A typical GPS receiver will include an antenna for receiving signals transmitted by GPS satellites, and positioning circuitry for determining a position of the GPS receiver from the signals and generating corresponding position data. The antenna may be integrated into the GPS receiver, or may be connected externally through a wire. A PND may integrate the GPS receiver with further circuitry and a display for providing functions that use the position data generated by the GPS receiver.

The PND will typically include an internal map, which can be used in conjunction with the position data to determine and display where the PND is located on the map. Based on this information, a navigator function of the PND may calculate a route along known thoroughfares in the map from the position of the PND to another known location. The route may then be displayed on a display of the PND, and instructions on upcoming maneuvers may be displayed on the PND and played through a speaker of the PND to alert the user as to which maneuvers should be taken to reach their destination as the user travels along the route.

As wireless transceivers and mobile phone data transmission technology increases in popularity and efficiency, greater numbers of PNDs are allowing for data connection with General Packet Radio Service (GPRS) modems, which are found in mobile phones, for example, and may be utilized to access networks, such as the Internet. This data connection to vast resources available online greatly enhances the PND as an information integrator and provider. The PND may be utilized to download information about points of interest (POIs), and may also be utilized to update databases with position-specific information on POIs, traffic, etc.

Returning to the subject of routing, or navigating, as sharing of position is enabled in the PNDs, demand is arising for new types of applications that utilize the positions of multiple PNDs to provide relevant information. One type of information obtainable by processing the positions of multiple PNDs is a rendezvous position or POI, however a method of calculating the rendezvous position and distributing the rendezvous position to the PNDs is yet to be taught by the prior art.

### SUMMARY OF THE INVENTION

According to the preferred embodiment of the present invention, a method of determining a rendezvous between a first personal navigation device and a second personal navigation device includes receiving a first location corresponding to the first personal navigation device, and a second location corresponding to the second personal navigation device. The rendezvous is determined based on the first location and the second location. The rendezvous is sent to the first personal navigation device and the second personal navigation device. The first personal navigation device determines a first route from the first location to the rendezvous, and the second personal navigation device determines a second route from the second location to the rendezvous.

According to a second embodiment of the present invention, a method of determining a rendezvous for at least three personal navigation devices includes receiving at least three locations corresponding to the at least three personal navigation devices. The rendezvous is determined based on the at least three locations. The rendezvous is sent to each of the at least three personal navigation devices, and the at least three personal navigation devices determine at least three corresponding routes from the at least three locations to the rendezvous.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of a process according to the preferred embodiment of the present invention.

FIG. 2 is a flowchart of a process according to the second embodiment of the present invention.

FIG. 3 is a diagram of illustrating determination of the rendezvous according to the preferred embodiment.

FIG. 4 is a diagram of illustrating determination of the rendezvous according to the second embodiment.

### DETAILED DESCRIPTION

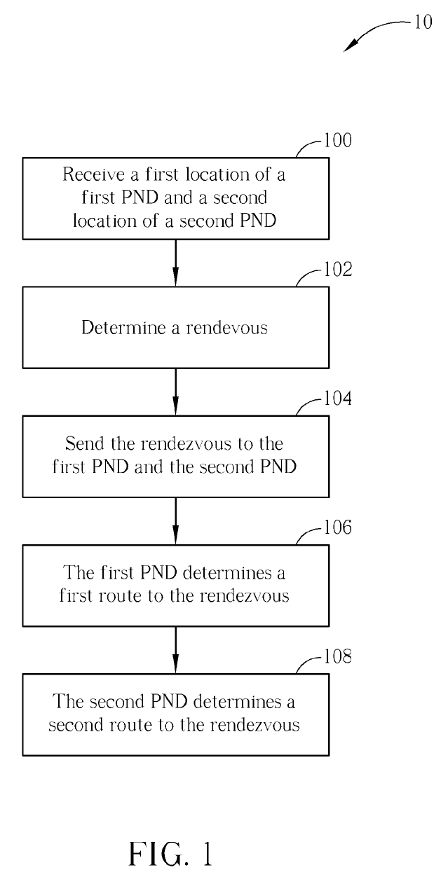

Please refer to FIG. 1, which shows a process 10 for determining a rendezvous between a first personal navigation device and a second personal navigation device according to the preferred embodiment of the present invention. The process 10 may be integrated as program code device-side or server-side, and comprises the following steps:

Step 100: Receive a first location of a first PND and a second location of a second PND.

Step 102: Determine a rendezvous.

Step 104: Send the rendezvous to the first PND and the second PND.

Step 106: The first PND determines a first route to the rendezvous.

Step 108: The second PND determines a second route to the rendezvous.

The process 10 may be conceived of in terms of address collection (Step 100), midpoint requirements, calculation (Step 102), and transmission (Step 104). Looking first at address collection, in Step 100, the process 10 starts with receiving the first location of the first PND and the second location of the second PND. The location may be an address, geographic coordinates, or even a POI, though the POI would most likely map to either or both of the former two. In the PND, the locations may be added to a trip planner page of a graphical user interface. Traditionally, a user would only enter their own destination in the trip planner page. However, in the present invention, the user may enter the first location and the second location in the trip planner page, and a function may be enabled to find the rendezvous. The function may be activated through pressing a rendezvous button on the PND, whether the rendezvous button be a physical button, or an icon in a graphical user display displayed in the PND. Of course, the user need not enter the first location manually, but may also allow the PND to determine the first location automatically through use of positioning circuitry of the PND. Likewise, the PND may also receive the second location automatically through a General Packet Radio Service (GPRS) modem with which the PND has a data connection.

Once the first location and the second location have been entered into the trip planner page, the user may also indicate midpoint requirements, or rendezvous criteria, for the rendezvous, such as restricting the rendezvous to a type of POI. Thus, the user may specify a type of POI criterion such as a type of restaurant, a type of store, a parking lot, or a tourist site. Thus, instead of the rendezvous being determined to be a busy intersection with no parking, through use of the type of POI criterion, the user may specify a fast food restaurant, or a big box retailer, such that all parties may easily find the rendezvous, and there is adequate parking for each driver. Or, by specifying a type of restaurant, e.g. Korean, the user may allow the PND to determine a suitable place for a group to meet up for dinner or a drink. Further criteria, such as ratings and price, may also be taken into consideration, so as to further narrow down choices for the rendezvous.

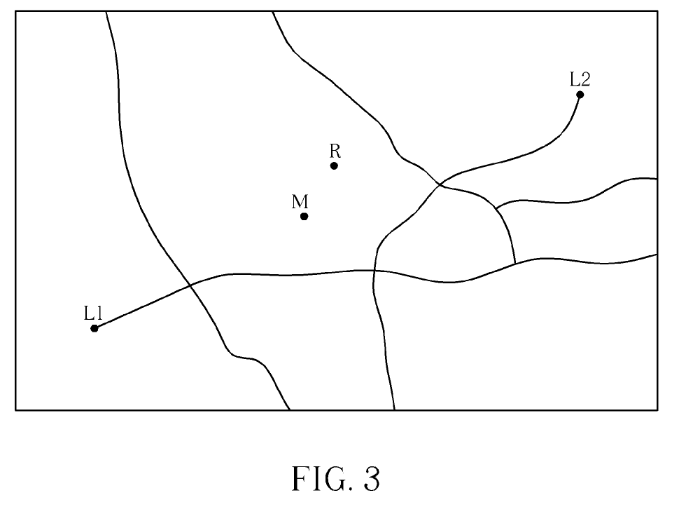

Please refer to FIG. 3, which is a diagram illustrating determination of the rendezvous. In the process 10, calculation of the rendezvous (Step 102) may be accomplished by determining a midpoint M that is approximately equidistant or has approximately the same travel time from a first location L1 and a second location L2, with preference for the latter. Once the suitable midpoint M has been found, an expanding search for the type of POI mentioned above may be performed around the midpoint M. When a rendezvous R matching the criteria for the expanding search is found, and selected, the first route and the second route may be calculated to provide a metric for a combination of the first route and the second route.

If the metric is acceptable, the rendezvous may be transmitted to the first PND and the second PND (Step 104). Transmission may be accomplished through SMS, an intermediary server, email, or other methods. Of course, if the rendezvous is calculated by the first PND, the rendezvous need not be transmitted to the first PND, but may be stored in a memory of the first PND for access by navigation software. If the rendezvous is calculated by a server, the server may transmit the rendezvous to both the first PND and the second PND. Once the rendezvous is received, the first PND may determine the first route from the first location to the rendezvous (Step 106), and the second PND may determine the second route from the second location to the rendezvous (Step 108). Steps 106 and 108 are well known in the art, and are also optional in the present invention.

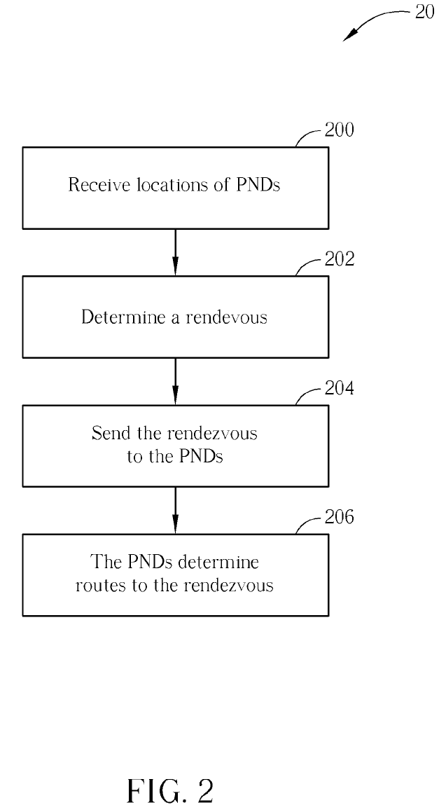

Please refer to FIG. 2, which shows a process 20 for determining a rendezvous for at least three personal navigation devices. The process 20 may be integrated as program code device-side or server-side, and comprises the following steps:

Step 200: Receive at least three locations corresponding to at least three PNDs.

Step 202: Determine a rendezvous.

Step 204: Send the rendezvous to the PNDs.

Step 206: The PNDs determine routes to the rendezvous.

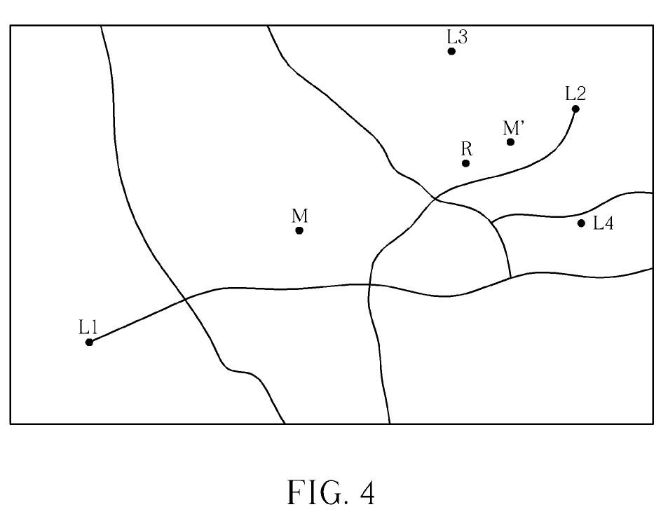

Please refer to FIG. 4, which is a diagram illustrating determination of the rendezvous for at least three locations. The process 20 is similar to the process 10, but is expanded for use with three or more PNDs at three or more different locations. In Step 200, for example, the user may enter a first location L1, a second location L2, a third location L3, a fourth location L4, and so on in the trip planner page. Or, the at least three locations may be received by the first PND automatically from the second PND, a third PND, and a fourth PND, respectively. The midpoint requirements mentioned above may be applied to the process 20 to determine a midpoint M. Then, in Step 202, the rendezvous may be determined by any of the PNDs mentioned above, or by the server. A more complex algorithm may be required for determining the midpoint, with an underlying requirement for minimizing a sum of journey times or a sum of distance traveled for all of the PNDs participating. A geographic center of the at least three locations may be found rather simply. However, the geographic center may not represent an optimum midpoint. The geographic center may be used as a target point for a series of A* graph searches, however. A* algorithms are well known in the art. Briefly, the A* algorithm calculates cost for each maneuver between a start point and the target point, and also estimates distance to the target point after each maneuver. Based on the cost and the estimated distance, the A* algorithm determines an optimal route between the start point and the target point. Estimation of the distance may be performed in various ways, and assuming a distance estimation algorithm employed never overestimates the estimated distance, the route found is optimal.

It is likely that one of the at least three locations may be an extreme outlier, which would skew the midpoint toward that one location. For example, if three of the four locations L2-L4 shown in FIG. 4 lie within a 20 mile radius, and the first location L1 of the at least three locations lies 100 miles away from the other three, the first location L1 may be considered an extreme outlier. In this example, the extreme outlier would require each of the other PNDs to travel further so that the PND at the fifth location may travel less distance or time. Thus, the present invention allows for weighting of the extreme outlier when one location is determined to be the extreme outlier relative to the at least two locations other than the one location. In this case, a weighted midpoint M′ may be determined based on weightings applied to each of the at least three locations L1-L4. As shown in FIG. 4, the weighted midpoint M′ may be further away from the extreme outlier than from the other three locations shown.

Again, once the suitable midpoint is found, e.g. the midpoint M or the weighted midpoint M′, the expanding search may be performed to find the POI that matches the rendezvous criteria, and the rendezvous may be sent to each of the at least three PNDs for determining the corresponding routes.

Compared to the prior art, the present invention allows multiple users of multiple PNDs to determine a suitable rendezvous based on their respective locations, and rendezvous criteria. Determination of the rendezvous may be handled in the PND or by the server, to allow for greater numbers of participants.

Those skilled in the art will readily observe that numerous modifications and alterations of the device and method may be made while retaining the teachings of the invention.

What is claimed is:

1. A method of determining a rendezvous between a first personal navigation device and a second personal navigation device, the method comprising:
receiving a first location corresponding to the first personal navigation device, and a second location corresponding to the second personal navigation device;
determining the rendezvous based on the first location and the second location;
sending the rendezvous to the first personal navigation device and the second personal navigation device;
the first personal navigation device determining a first route from the first location to the rendezvous; and
the second personal navigation device determining a second route from the second location to the rendezvous.

2. The method of claim 1, further comprising:
specifying a rendezvous criterion for the rendezvous;
wherein determining the rendezvous based on the first location and the second location is determining the rendezvous based on the first location, the second location, and the rendezvous criterion.

3. The method of claim 2, wherein specifying the rendezvous criterion for the rendezvous is specifying a type of point of interest criterion for the rendezvous.

4. The method of claim 3, wherein specifying the type of point of interest criterion for the rendezvous is specifying a restaurant for the rendezvous.

5. The method of claim 3, wherein specifying the type of point of interest criterion for the rendezvous is specifying a tourist site for the rendezvous.

6. The method of claim 3, wherein specifying the type of point of interest criterion for the rendezvous is specifying a parking area for the rendezvous.

7. The method of claim 1, wherein determining the rendezvous based on the first location and the second location is determining the rendezvous having substantially minimal and similar travel distances from the first location and the second location.

8. The method of claim 1, wherein determining the rendezvous based on the first location and the second location is determining the rendezvous having substantially minimal and similar travel times from the first location and the second location.

9. A method of determining a rendezvous for at least three personal navigation devices, the method comprising:
receiving at least three locations corresponding to the at least three personal navigation devices;
determining the rendezvous based on the at least three locations;
sending the rendezvous to each of the at least three personal navigation devices;
the at least three personal navigation devices determining at least three corresponding routes from the at least three locations to the rendezvous.

10. The method of claim 9, further comprising:
specifying a rendezvous criterion for the rendezvous;
wherein determining the rendezvous based on the at least three locations is determining the rendezvous based on the at least three locations and the rendezvous criterion.

11. The method of claim 10, wherein specifying the rendezvous criterion for the rendezvous is specifying a type of point of interest criterion for the rendezvous.

12. The method of claim 11, wherein specifying the type of point of interest criterion for the rendezvous is specifying a restaurant for the rendezvous.

13. The method of claim 11, wherein specifying the type of point of interest criterion for the rendezvous is specifying a tourist site for the rendezvous.

14. The method of claim 11, wherein specifying the type of point of interest criterion for the rendezvous is specifying a parking area for the rendezvous.

15. The method of claim 9, wherein determining the rendezvous based on the at least three locations is determining the rendezvous having minimal total travel distance from the at least three locations.

16. The method of claim 9, wherein determining the rendezvous based on the at least three locations is determining the rendezvous having minimal total travel time from the at least three locations.

17. The method of claim 9, wherein determining the rendezvous based on the at least three locations comprises:
determining a geographic center of the at least three locations; and
performing a plurality of A* graph searches to determine the rendezvous based on the geographic center;
wherein a first A* graph search of the plurality of A* graph searches utilizes the geographic center as a target point.

18. The method of claim 9, further comprising:
weighting one location of the at least three locations when the one location is determined to be an extreme outlier relative to the at least two locations other than the one location.

19. The method of claim 9, wherein determining the rendezvous based on the at least three locations comprises:
determining a plurality of rendezvous candidates based on the at least three locations; and
selecting the rendezvous from the plurality of rendezvous candidates.

20. The method of claim 9, wherein determining the rendezvous based on the at least three locations is a server determining the rendezvous based on the at least three locations.

21. The method of claim 9, wherein determining the rendezvous based on the at least three locations is one personal navigation device of the at least three personal navigation devices determining the rendezvous based on the at least three locations.
